(19) United States
(12) Patent Application Publication
(10) Pub. No.: US 2024/0268593 A1
(43) Pub. Date: Aug. 15, 2024

(54) COLANDER WITH ROTATING HANDLE

(71) Applicant: Lifetime Brands, Inc., Garden City, NY (US)

(72) Inventors: Matthew Krus, Seattle, WA (US); Ian Morgan, Seattle, WA (US); Samantha Piercy, Edmonds, WA (US)

(21) Appl. No.: 18/166,829

(22) Filed: Feb. 9, 2023

(51) Int. Cl. A47J 19/00

(52) U.S. Cl. CPC A47J 19/005

(57) ABSTRACT

A colander includes a split handle having a top handle coupled to a top rim and a bottom handle coupled to a bottom rim, the bottom handle being rotatable with respect to the top handle and a body having a plurality of perforations and being attached to the bottom rim. The body is collapsible and a bottommost surface of the body is generally flat. The bottom handle rotates either 90°, 180° or 360° with respect to the top handle.

### FIELD OF INVENTION

The present invention relates generally to kitchen utensils, and more specifically, to a colander with a rotating handle.

### BACKGROUND

Colanders are a popular kitchen utensil that allows users to drain liquid and rinse food. Some of the most common reasons for the use of colanders or strainers, are for rinsing contaminants from fruits and vegetables, and draining the cooking fluids used with pasta and other items. Typically, conventional colanders have allowed the contents within the colander to be suspended above the basin of a sink, thereby allowing water and other fluids to be drained and disposed. The colander is also particularly beneficial for preventing contamination of the contents therein.

Large kitchen items such as bowls and colanders can be difficult to store. They can take up to an inordinate amount of space in a kitchen cabinet or drawer, making it cumbersome to retrieve the item and replace it when finished.

### SUMMARY

In accordance with an embodiment, a colander is provided. The colander includes a split handle having a top handle coupled to a top rim and a bottom handle coupled to a bottom rim, the bottom handle being rotatable with respect to the top handle and a body having a plurality of perforations and being attached to the bottom rim. The body is collapsible and a bottommost surface of the body can be generally flat. The bottom handle rotates either 90°, 180° or 360° with respect to the top handle.

In accordance with another embodiment, a collapsible colander is provided. The collapsible colander includes a first handle coupled to a first rim, a second handle coupled to a second rim and being rotatable with respect to the first handle, and a flexible membrane attached to the first and second rims. A bottommost surface of the flexible membrane is generally flat. The second handle rotates either 90°, 180° or 360° with respect to the first handle.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a perspective view of a colander, in accordance with an embodiment of the present invention;

FIG. 2 is a top view of the colander of FIG. 1, in accordance with an embodiment of the present invention;

FIG. 3 is an exploded view of the colander of FIG. 1, in accordance with an embodiment of the present invention;

FIG. 4A is a side view of the colander of FIG. 1 in an expanded state, in accordance with an embodiment of the present invention;

FIG. 4B is a side view of the colander of FIG. 1 in a collapsed state, in accordance with an embodiment of the present invention;

FIG. 4C is a side view of the colander of FIG. 1 where one handle rotates up to 180° with respect to the other handle, in accordance with an embodiment of the present invention;

FIG. 5 is a cross-sectional view of the colander of FIG. 1, in accordance with an embodiment of the present invention; and

FIG. 6 is a perspective view of the colander of FIG. 1 with one handle rotated up to 180° with respect to the other handle and placed over a sink, in accordance with an embodiment of the present invention.

Throughout the drawings, same or similar reference numerals represent the same or similar elements.

### DETAILED DESCRIPTION

Embodiments in accordance with the present invention provide for a colander with a split handle having a first handle and a second handle. The second handle rotates with respect to the first handle. In a closed state, the first handle is positioned directly over the second handle. In a rotated or open state, the second handle can rotate up to 180° with respect to the first handle. In other embodiments, the second handle can rotate up to 360° with respect to the first handle. In another embodiment, the second handle can rotate up to 90°. The rotation of the second handle with respect to the first handle enables the colander to be positioned for use over a sink using the handles as support. The body or membrane of the colander is collapsible and includes a generally or substantially flat bottom surface to securely be placed or positioned or maintained on flat surfaces.

In some instances, others have created collapsible colanders to reduce the storage space required. But existing collapsible colanders have several drawbacks. Some collapsible colanders are made of a single material, generally a type of plastic, with multiple pleats. The design makes them hard to expand and collapse because the material is relatively stiff and a substantial force is required. In some instances, collapsible strainers have been formed entirely from a flexible material. This design allows the item to be readily flattened, but because the material is so flexible it is not self-supporting and will collapse when placed on a surface. Accordingly, there is a need for an improved collapsible colander for secure positioning over a sink and for easy storage. The exemplary embodiments of the present invention provide for a collapsible colander having two handles, where one handle rotates with respect to the other such that the handles can be positioned up to 180° with respect to each other so that the handles can secure the collapsible colander over a sink for use by a user.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

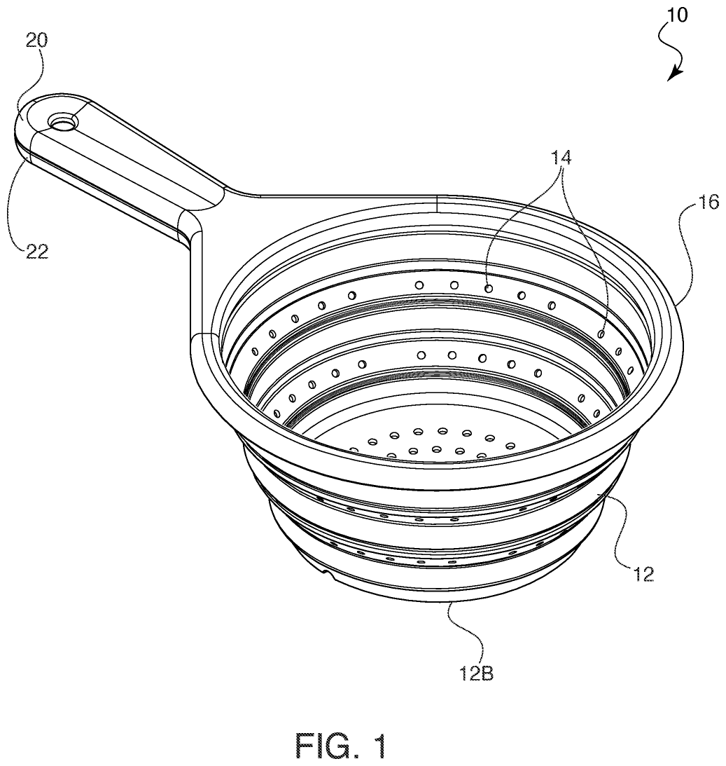

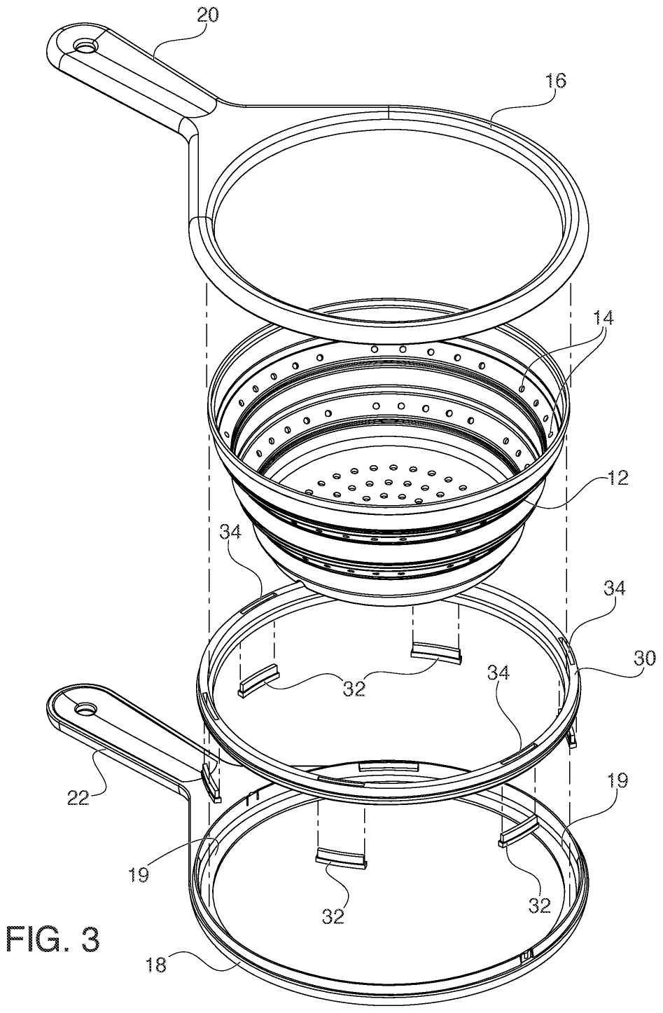

FIG. 1 is a perspective view of a colander 10, in accordance with an embodiment of the present invention. The colander 10 includes a body 12 attached to two rims, that is, rim 16 and rim 18 (FIG. 3). The rim 16 can be referred to as a top or upper rim and the rim 18 can be referred to as a bottom or lower rim. A top handle 20 extends from the top rim 16 and a bottom handle 22 extends from the bottom rim 18. The body 12 includes a plurality of perforations 14. A bottom surface 12B of the body 12 can be generally or substantially flat. The body 12 is collapsible. The body 12 can also be referred to as a membrane or a flexible membrane.

The body 12 of the colander 10 includes a plurality of perforations 14 to allow drainage when the body 12 is filled with food items. The size, shape, and arrangement of the plurality of perforations 14 may vary. In one example, the body 12 may include a first plurality of generally circular holes and a second plurality of generally oval holes.

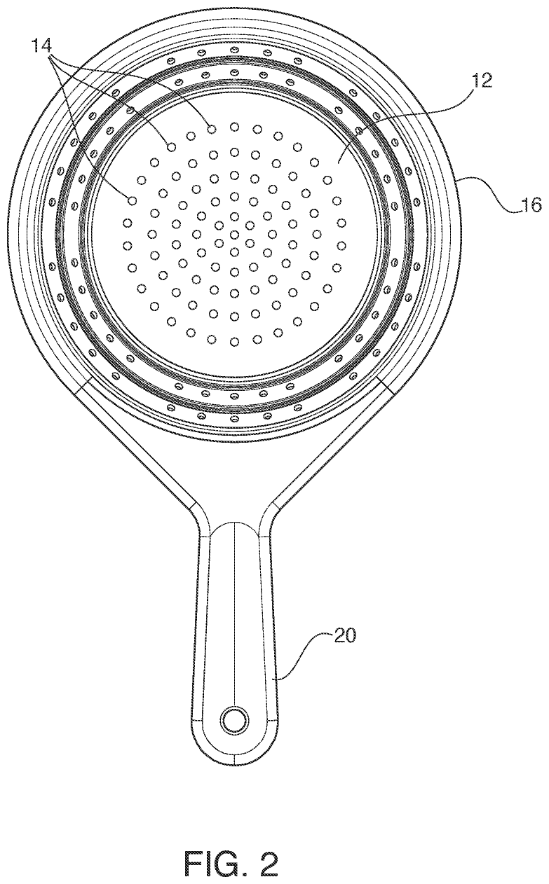

FIG. 2 is a top view of the colander 10 of FIG. 1, in accordance with an embodiment of the present invention. The top view better shows the top handle 20 and the top rim 16. The top view also shows the plurality of perforations 14 in the body 12.

FIG. 3 is an exploded view of the colander 10 of FIG. 1, in accordance with an embodiment of the present invention. The exploded view clearly shows the top handle 20 and the bottom handle 22.

The top handle 20 is attached to a rigid rim 16.

The bottom handle 22 is attached to a rigid rim 18. The rim 18 defines a circumferential area 19 that can be configured to receive a rim connector 30. The rim connector 30 includes a plurality of slots 34. A plurality of tabs 32 are configured to be inserted into the plurality of slots 34 of the rim connector 30 to connect the bottom rim 18 to the body 12. The body 12 with the plurality of perforations 14 is shown directly between the rim connector 30 and the top rim 16.

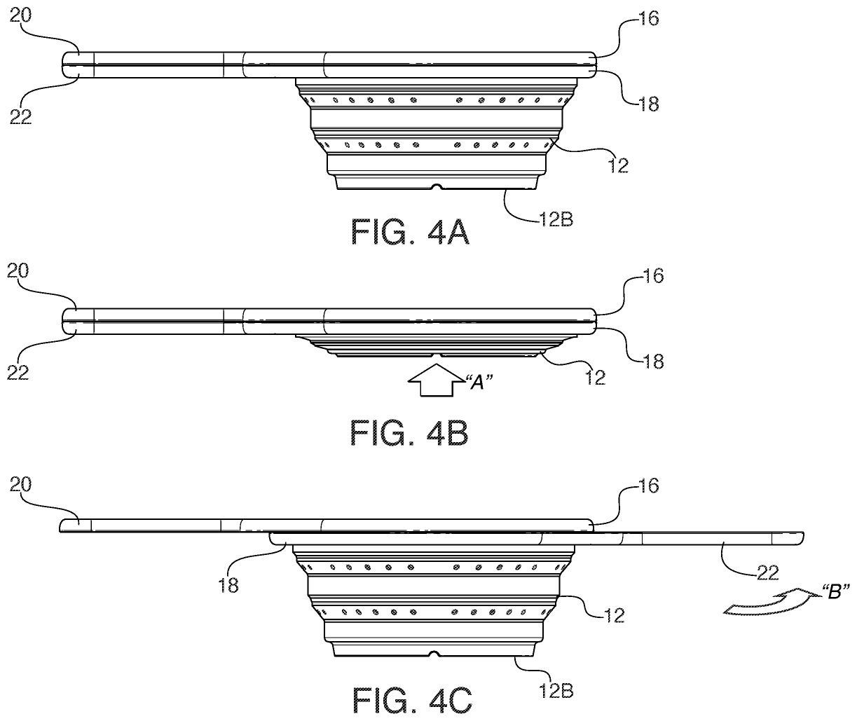

FIG. 4A is a side view of the colander 10 of FIG. 1 in an expanded state, in accordance with an embodiment of the present invention. In the expanded state, the body 12 is ready to receive or accept food items. The bottom surface 12B of the body 12 can be flat. The flat bottom surface 12B allows the colander 10 to securely be placed or positioned on a surface, such as a countertop or a basin of a sink.

FIG. 4B is a side view of the colander 10 of FIG. 1 in a collapsed state, in accordance with an embodiment of the present invention. In the collapsed state, the body 12 can be moved in a direction “A” such that the body 12 is substantially flat and positioned against the bottom rim 18.

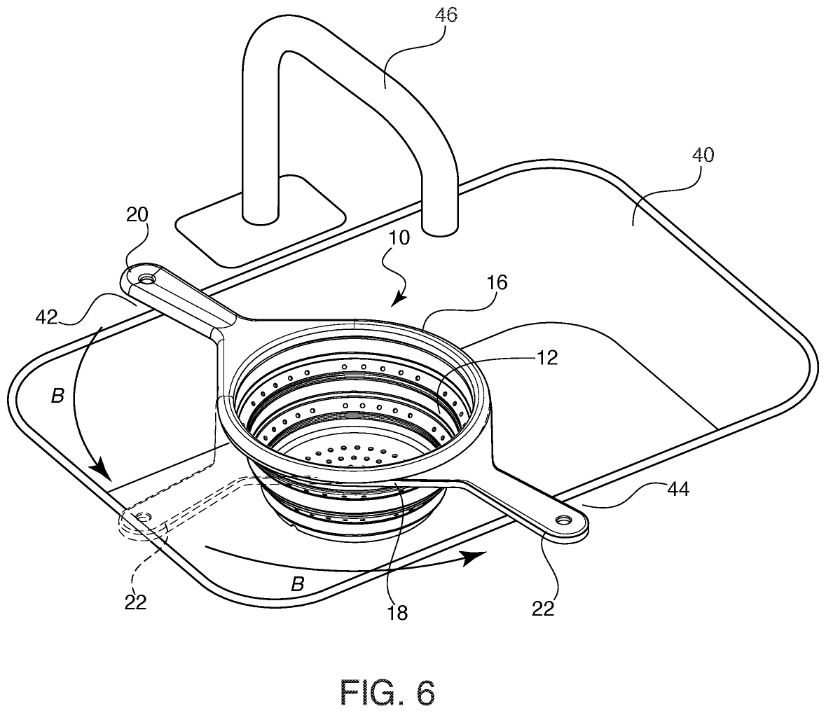

FIG. 4C is a side view of the colander 10 of FIG. 1 where one handle 22 rotates up to 180° with respect to the other handle 20, in accordance with an embodiment of the present invention. In this view, the bottom handle 22 can be rotated in a direction “B” such that the top handle 20 is 180° in relation to the bottom handle 22. In one example, the bottom handle 22 rotates up to 180°. In another example, the bottom handle rotates up to 360°. In another embodiment, the bottom handle 22 rotates up to 90°. The bottom handle 22 preferably always remains parallel to the top handle 20. However, the bottom handle 22 can be horizontally offset from the top handle 20. In this rotated or open configuration, the top handle 20 and the bottom handle 22 can be placed on opposed ends of a sink 40 (FIG. 6) to stabilize the colander 10 over the sink 40.

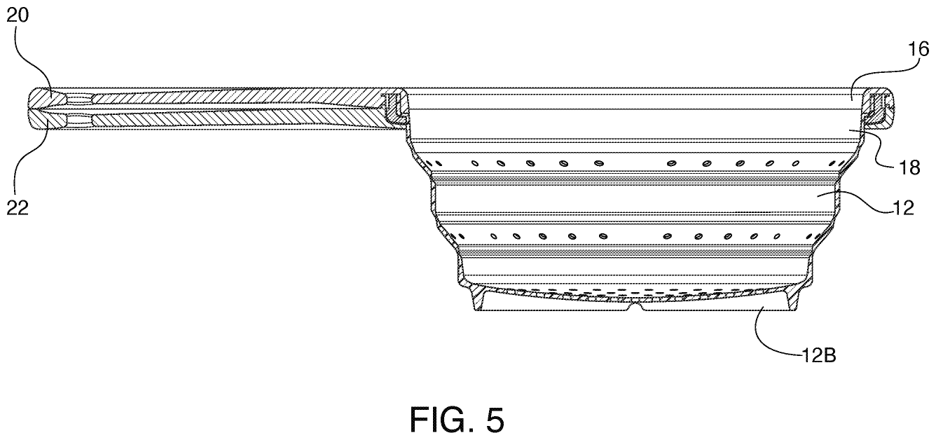

FIG. 5 is a cross-sectional view of the colander 10 of FIG. 1, in accordance with an embodiment of the present invention. The cross-sectional view better shows the rotating relationship between the top handle 20 and the bottom handle 22. The cross-sectional view also shows the body 12 and the flat base 12B.

FIG. 6 is a perspective view of the colander 10 of FIG. 1 with one handle rotated 180° with respect to the other handle and placed over a sink, in accordance with an embodiment of the present invention. The colander 10 is shown placed over a sink 40 having a faucet 46. The bottom handle 22 has been rotated such that the top handle 20 and the bottom handle 22 are in a 180° relationship. The top handle 20 can be placed on surface or edge 42 of the sink 40 and the bottom handle 22 can be placed on surface or edge 44 of the sink 40. The body 12 of the colander 10 has been expanded to accept food items therein. Therefore, the bottom handle 22 can be rotated to easily place the colander 10 over a sink 40. After use, the bottom handle 22 can be rotated to its initial position (directly under the top handle 20) for quick and easy storage.

In summary, the exemplary embodiments present a colander with a split handle having a first handle and a second handle. The second handle rotates with respect to the first handle. In a closed state, the first handle is positioned directly over the second handle. In a rotated or open state, the second handle can rotate up to 180° with respect to the first handle. In other embodiments, the second handle can rotate up to 360° with respect to the first handle. The rotation of the second handle with respect to the first handle enables the colander to be positioned for use over a sink. The body or membrane of the colander is collapsible and includes a generally or substantially flat bottom surface to securely be maintained or positioned or placed on flat surfaces.

In one embodiment, the colander 10 includes a split handle having a top handle 20 coupled to a top rim 16, a bottom handle 22 coupled to a bottom rim 18, the bottom handle 22 configured to rotate with respect to the top handle 20, and a body 12 having a plurality of perforations 14, the body 12 attached to the bottom rim 18. The body 12 is collapsible and a bottommost surface of the body 12 is generally flat. The bottom handle 22 rotates either 90°, 180° or 360° with respect to the top handle 20. A rim connector 30 can be disposed between the top rim 16 and the bottom rim 18. The rim connector 30 is disposed within a circumferential area 19 defined by the bottom rim 18. The rim connector 30 has a plurality of slots 34 to receive a plurality of respective tabs 32 to secure the bottom rim 18 to the body 12. The top handle 20 can be horizontally offset from the bottom handle 22. In a closed state, the top handle 20 is placed directly over the bottom handle 22.

In another embodiment, the collapsible colander 10 includes a first handle 20 coupled to a first rim 16, a second handle 22 coupled to a second rim 18, the second handle 22 configured to rotate with respect to the first handle 20, and a flexible membrane 12 attached to the second rim 18. A bottommost surface of the flexible membrane 12 is generally flat. The second handle 22 rotates either 90°, 180° or 360° with respect to the first handle 20. A rim connector 30 can be disposed between the first rim 16 and the second rim 18. The rim connector 30 can be disposed within a circumferential area 19 defined by the second rim 18. The rim connector 30 has a plurality of slots 34 to receive a plurality of respective tabs 32 to secure the second rim 18 to the flexible membrane 12.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

1. A colander comprising:
a split handle having a top handle coupled to a top rim and a bottom handle coupled to a bottom rim, the bottom handle being rotatable with respect to the top handle; and
a body having a plurality of perforations and being attached to the bottom rim.

2. The colander of claim 1, wherein the body is collapsible.

3. The colander of claim 1, wherein a bottommost surface of the body is generally flat.

4. The colander of claim 1, wherein the bottom handle rotates up to 180° with respect to the top handle.

5. The colander of claim 1, wherein the bottom handle rotates up to 360° with respect to the top handle.

6. The colander of claim 1, further comprising a rim connector disposed between the top rim and the bottom rim to secure the bottom rim to the body.

7. The colander of claim 6, wherein the rim connector is disposed within a circumferential area defined by the bottom rim.

8. The colander of claim 7, wherein the rim connector has a plurality of slots to receive a plurality of respective tabs to secure the bottom rim to the body.

9. The colander of claim 1, wherein the top handle is horizontally offset from the bottom handle.

10. The colander of claim 1, wherein, in a closed state, the top handle is placed directly over the bottom handle.

11. A collapsible colander comprising:
a first handle coupled to a first rim;
a second handle coupled to a second rim and being rotatable with respect to the first handle; and
a flexible membrane attached to the first and second rims.

12. The collapsible colander of claim 11, wherein a bottommost surface of the flexible membrane is generally flat.

13. The collapsible colander of claim 11, wherein the second handle rotates up to 180° with respect to the first handle.

14. The collapsible colander of claim 11, wherein the second handle rotates up to 360° with respect to the first handle.

15. The collapsible colander of claim 11, further comprising a rim connector disposed between the first rim and the second rim to secure the second rim to the flexible membrane.

16. The collapsible colander of claim 15, wherein the rim connector is disposed within a circumferential area defined by the second rim.

17. The collapsible colander of claim 16, wherein the rim connector has a plurality of slots to receive a plurality of respective tabs to secure the second rim to the flexible membrane.
